(19) United States
(12) Patent Application Publication
(10) Pub. No.: US 2026/0225627 A1
(43) Pub. Date: Aug. 6, 2026

(54) RAIL VEHICLE

(71) Applicant: Siemens Mobility GmbH, München (DE)

(72) Inventors: Behcet Ciftci, Oberhausen (DE); Benjamin Ricken, Bergisch Gladbach (DE); Peter Dornberger, Nürnberg (DE); Markus Ehrig, Tönisvorst (DE); Markus Sommerfeld, Krefeld (DE); Holger Leukel, Solingen (DE)

(21) Appl. No.: 19/151,433

(22) PCT Filed: Dec. 28, 2023
(86) PCT No.: PCT/EP2023/087925

§ 371 Date: Jul. 28, 2025

(30) Foreign Application Priority Data
Jan. 27, 2023 (DE) 10 2023 200 685.5

(51) Int. Cl. B61D 27/00; B60H 3/06

(52) U.S. Cl. CPC B61D 27/0018; B60H 3/06; B61D 27/0072

(57) ABSTRACT

A rail vehicle includes at least a vehicle interior, a climate control and air supply installation for the vehicle interior including an intake for supplying outside ambient air to the vehicle interior, and at least one aggregate or assembly. The rail vehicle is configured to supply the aggregate or assembly with air from the vehicle interior.

The invention relates to a rail vehicle, comprising at least one vehicle interior space, a climate control and air supply installation for the vehicle interior space with an intake for the supply of outside air into the vehicle interior space, and at least one aggregate.

In rail vehicles, some components on the ceiling or in the subfloor, such as climate control installations, air supply systems, etc., require an outside air intake. Since a high proportion of sand and dust is present in the drawn-in air in certain regions or climate zones, complex sand filter systems have to be used for the components, and the interfaces have to be sealed off from dust. This leads to elaborate constructions and shorter maintenance intervals or frequent failures of components such as filters and fans.

The components, such as climate control installations and air supply installations, have to be protected from a high proportion of dust and dust particles during the intake of outside air by way of specific filter systems with filters, gratings or separators for example, or must be designed to be particularly robust in relation to said environmental influences. This is the case in particular if a train is traveling through an area such as a desert, in which the outside air (ambient air) is heavily loaded with particles, such as sand for example. Usually, the exhaust air of the climate control system is blown out of the vehicle without further targeted use.

In addition to the vehicle interior space, air cooling is likewise required by aggregates under certain climate conditions, in order to achieve their function or protect their components. As natural convection is generally insufficient for cooling, outside air is used for cooling. Fans and specific filter systems are also necessary in this case. The entry of sand should also be avoided here. The drawn-in outside air is guided through particle separators and/or filters and gratings, in order to reduce the particle load to a tolerable amount. Alternatively, the aggregates or parts such as heat exchangers, pumps/compressors in these systems are designed to be particularly robust, in order to withstand the particularly aggressive environmental influences.

In construction machines, the air flow through the heat exchanger is optionally briefly reversed, in order to blow off detached particles. This, for example, does not help against abrasion due to sand, for example, and is not helpful.

In both cases, more elaborate and/or additional components are used. This is mostly associated with an increased service outlay for the cleaning of filters, for example.

Starting from this, the invention is based on the object of providing a rail vehicle, which is embodied in a structurally simpler manner and reduces the maintenance outlay. This object is achieved by the features of claim 1. Advantageous embodiments and developments are the subject matter of the sub-claims.

According to the invention, a rail vehicle is provided, comprising at least one vehicle interior space, a climate control and air supply installation for the vehicle interior space with an intake for the supply of outside air into the vehicle interior space, and at least one aggregate. In this context, the rail vehicle is embodied for supplying air to the aggregate using air from the vehicle interior space.

By using the air from the vehicle interior space to cool aggregates, it is possible to save on specific filter installations, fans and elaborate constructions for sealing off the interfaces from dust.

In order to minimize or avoid elaborate equipment of the air-guiding systems, the air from the vehicle interior space is used.

This would already be cleaned by the climate control and air supply installation of the rail vehicle on intake and, after the primary use in the vehicle interior space (for example passenger compartment), is only slightly loaded with particles (compared to the outside air in deserts, for example, which is heavily loaded with sand particles). If this air is guided out of the vehicle interior space in a targeted manner by aggregates such as cooling installations for transformers, traction motors or galley cooling aggregates, for example, then the load due to the ambient air (outside air) drawn in from the outside is reduced or omitted.

Furthermore, the energy efficiency of the rail vehicle can be increased, as at increased ambient temperature the outgoing air of the climate control and air supply installation, i.e. the air from the vehicle interior space, is cooler than the outside air. Thus, heat exchange processes for cooling are more efficient if the exhaust air of the climate control and air supply installation is used. Specifically in deserts, the air humidity of the outside air (ambient air) is low. The exhaust air (outgoing air) of the climate control and air supply installation is usually loaded with an increased relative air humidity, due to the passengers in the rail vehicle for example. With correct use, this further increases the efficiency of the thermodynamic cooling process.

Through the targeted use of the outgoing air (exhaust air) of the climate control and air supply installation, the outlay and the costs for equipping rail vehicles in particularly aggressive environments, such as deserts for example, are minimized. Additionally, the energy efficiency of the rail vehicle is increased.

The vehicle interior space can preferably involve a passenger compartment.

According to the invention, this provides a possibility for blowing the air out from the interior space via an aggregate to be cooled.

In a development of the rail vehicle, it can be provided that the at least one aggregate is or comprises an aggregate that is arranged outside the vehicle interior space.

This makes it possible to supply the outgoing air of the interior space to an aggregate that is arranged outside of the interior space.

It can further be provided that, as an alternative or in addition, the at least one aggregate 200 is or comprises an aggregate 200 that is arranged inside the vehicle interior space 10.

This makes it possible to supply the outgoing air of the interior space to an aggregate that is arranged inside the interior space.

In an advantageous development of the rail vehicle, it can be provided that the rail vehicle has an air supply apparatus, which is embodied in such a manner that it supplies the aggregate with air from the interior space.

For this, a corresponding intake is embodied in the vehicle interior space in the vicinity of the aggregate.

It can further be provided that the air supply apparatus has an outgoing air aggregate, which draws in air from the vehicle interior space and supplies it to the aggregate.

This achieves that the outgoing air (exhaust air) is discharged out from the vehicle interior space through the outgoing air aggregate and out from the vehicle interior space in a targeted manner, and is supplied to the aggregate.

In addition, an elaborate equipping of the air-guiding systems is minimized and the air that has to be discharged out from the vehicle interior space is supplied to the aggregate in a targeted manner.

It can further be provided that the climate control and air supply installation has at least one air conditioning facility for conditioning the outside air to be supplied to the vehicle interior space. The conditioning of the air can comprise the adaptation of the air temperature and the air humidity in this case, for example. It can be provided in this context that the air conditioning facility conditions the air in relation to the use in the vehicle interior space. Furthermore, during the conditioning of the outside air it is possible to take into consideration that it is supplied to the at least one aggregate after flowing through the vehicle interior space.

In a development, it can further be provided that the climate control and air supply installation has at least one sand and dust filter system, for filtering the received outside air.

This filters out the sand and dust from the outside air, before this is supplied to the rail vehicle.

The outgoing air, which has already been pre-cleaned, of the climate control and air supply installation can likewise be supplied to a compressed air generation apparatus in the rail vehicle, in order to minimize the preparation of the drawn-in air here as well.

This makes it possible to reduce the apparatus-related outlay for the generation of compressed air.

The compressed air generation apparatus is embodied to supply compressed air to a compressed air system of the rail vehicle. Compressed-air brakes or other pneumatic systems are connected to the compressed air system, for example.

In an embodiment, it can be provided that the climate control and air supply installation is arranged above the vehicle interior space. Preferably, the climate control and air supply installation is arranged in the ceiling region of the rail vehicle. The climate control and air supply installation is thus preferably arranged on the car body.

This achieves that the climate control and air supply installation is arranged at the location at which the least dust arises and is able to draw in the outside air directly in the ceiling region. Through the arrangement of the climate control and air supply installation in the ceiling region, it is also achieved that available structural space is used in this manner.

It can further be provided that the aggregate is arranged below the vehicle interior space, preferably in the subfloor region. This achieves that the aggregate is arranged at a location which gives the rail vehicle a low center of gravity. In the event that the climate control and air supply installation is arranged in the ceiling region, it is also possible to achieve that air flows through the vehicle interior space from top to bottom.

In a development of the rail vehicle, it can be provided that no filter is arranged between the vehicle interior space and the aggregate. The air is thus supplied out from the vehicle interior space and to the aggregate directly and without further filtering or conditioning.

The apparatus-related outlay and also the maintenance outlay during operation are kept low thereby.

Alternatively, in a development of the rail vehicle, an additional sand or dust filter can be arranged between the vehicle interior space and the aggregate. This additional sand or dust filter can be embodied as a fine filter or as a filter mat, for example. This specifies a less cost- and/or maintenance-intensive means for supplying further-filtered air to the aggregate.

In an embodiment of the rail vehicle, it can further be provided that the at least one aggregate is assigned an outside air supply apparatus that is arranged in the region of the aggregate and via which it is possible to supply the at least one aggregate with outside air from the surrounding area of the aggregate for cooling purposes, preferably in addition to the air at the vehicle interior space.

If the required volumetric flow of air for the aggregate is greater than the volumetric flow given off from the vehicle interior space (outgoing air of the climate control and air supply installation), on a temporary or ongoing basis (for example in the case of traction motor cooling), then this can be used partially as drawn-in air and thus reduces at least the entry of particles and thus the loading of the aggregate.

The invention will now be explained below using exemplary embodiments with reference to the drawings, in which:

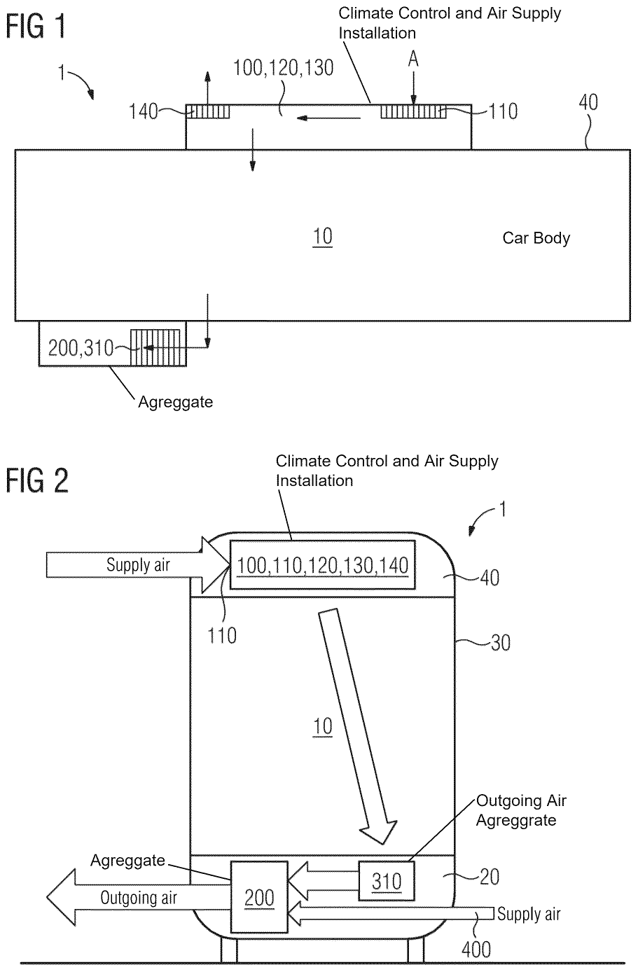

FIG. 1 shows a schematic representation of a rail vehicle according to the invention with a climate control and air supply installation according to a first embodiment; and

FIG. 2 shows a schematic representation of a rail vehicle according to the invention with a climate control and air supply installation according to a second embodiment.

FIG. 1 shows a schematic representation of a rail vehicle 1 according to the invention with a climate control and air supply installation 100 according to a first embodiment.

The rail vehicle 1 comprises at least a vehicle interior space 10 and a climate control and air supply installation 100 for the vehicle interior space 10.

The climate control and air supply installation 100 has an intake 110 for supplying outside air into the vehicle interior space 10.

The rail vehicle further comprises at least one aggregate 200.

According to FIG. 1, the at least one aggregate 200 is arranged outside the vehicle interior space 10, but as an alternative or in addition can also be/comprise an aggregate 200 that is arranged inside the vehicle interior space 10.

As can be seen from FIG. 1, the rail vehicle 1 is embodied for supplying air to the aggregate 200 using air from the vehicle interior space 10.

According to FIG. 1, the rail vehicle has an air supply apparatus 300, which is embodied in such a manner that it supplies the aggregate 200 with air from the vehicle interior space 10.

According to FIG. 1, a car of the rail vehicle 1 is shown as an example. The car body 40 has the vehicle interior space 10.

Furthermore, the air supply apparatus 300 has an outgoing air aggregate 310, which draws in air from the vehicle interior space 10 and supplies it to the aggregate 200.

The climate control and air supply installation 100 has at least one air conditioning facility 120 for conditioning the outside air to be supplied to the vehicle interior space 10. The air conditioning facility 120 is embodied to condition the outside air in relation to the temperature and/or air humidity, before this is supplied to the vehicle interior space 10.

Furthermore, the climate control and air supply installation 100 has at least one sand and dust filter system 130, for filtering the received outside air.

Furthermore, the climate control and air supply installation 100 can have an outlet 140, which is embodied to supply a part of the air drawn in through the intake 110 to the surrounding area again after it has flowed through the climate control and air supply installation 100.

The climate control and air supply installation 100 is arranged above the vehicle interior space 10. In particular, the climate control and air supply installation 100, as shown in FIG. 1, is arranged on the car body 40 in the ceiling region. The climate control and air supply installation 100 comprises the intake 110, the air conditioning apparatus 120, the sand and dust filter system 130 and the outlet 140, which are arranged above the vehicle interior space 10.

The aggregate 200 is arranged below the vehicle interior space 100, preferably in the subfloor region 20.

No filter is arranged between the vehicle interior space 10 and the aggregate 200. Rather, the air is supplied out from the vehicle interior space and to the aggregate directly.

FIG. 2 shows a schematic representation of a rail vehicle 1 according to the invention with a climate control and air supply installation 100 according to the second embodiment.

In this context, the rail vehicle 1 of the second embodiment is based on the first embodiment, wherein subsequently only the differences between the second embodiment and the first embodiment are essentially presented.

As can be seen from FIG. 2, the rail vehicle 1 according to the second embodiment, just as the rail vehicle 1 of the first embodiment (cf. FIG. 1), is embodied for supplying air to the aggregate 200 using air from the vehicle interior space 100.

The aggregate 200 is assigned an outside air supply apparatus 400 that is arranged in the region of the aggregate and via which it is possible to supply the aggregate 200 with outside air from the surrounding area of the aggregate 200 for cooling purposes. The outside air supply apparatus 400 can be operated on demand, meaning that the outside air supply apparatus 400 can be activated when the volumetric flow of the air from the vehicle interior space 10 is not sufficient.

1-12. (canceled)

13. A rail vehicle, comprising:
at least one vehicle interior space;
a climate control and air supply installation for said vehicle interior space, said climate control and air supply installation having an intake for supplying outside air into said at least one vehicle interior space; and
at least one aggregate receiving air supplied to said at least one aggregate from said at least one vehicle interior space.

14. The rail vehicle according to claim 13, wherein said at least one aggregate is an aggregate disposed outside said at least one vehicle interior space.

15. The rail vehicle according to claim 13, wherein said at least one aggregate is an aggregate disposed inside said at least one vehicle interior space.

16. The rail vehicle according to claim 13, which further comprises an air supply apparatus configured to supply said at least one aggregate with air from said at least one vehicle interior space.

17. The rail vehicle according to claim 16, wherein said air supply apparatus has an outgoing air aggregate configured to draw-in air from said at least one vehicle interior space and to supply the drawn-in air to said at least one aggregate.

18. The rail vehicle according to claim 13, wherein said climate control and air supply installation includes at least one air conditioning facility for conditioning the outside air to be supplied to said at least one vehicle interior space.

19. The rail vehicle according to claim 13, wherein said climate control and air supply installation includes at least one sand and dust filter system for filtering the received outside air.

20. The rail vehicle according to claim 13, wherein said climate control and air supply installation is disposed above said at least one vehicle interior space.

21. The rail vehicle according to claim 13, wherein said at least one aggregate is disposed below said at least one vehicle interior space.

22. The rail vehicle according to claim 21, wherein said at least one aggregate is disposed in a subfloor region below said at least one vehicle interior space.

23. The rail vehicle according to claim 13, wherein no filter is disposed between said at least one vehicle interior space and said at least one aggregate.

24. The rail vehicle according to claim 19, which further comprises an additional sand or dust filter disposed between said at least one vehicle interior space and said at least one aggregate.

25. The rail vehicle according to claim 13, which further comprises an outside air supply apparatus associated with said at least one aggregate, said outside air supply apparatus being disposed in a region of said at least one aggregate and said outside air supply apparatus permitting said at least one aggregate to be supplied with outside air from a surrounding area of said at least one aggregate for cooling purposes.

26. The rail vehicle according to claim 25, wherein said outside air supply apparatus supplies said at least one aggregate with outside air from the surrounding area of said at least one aggregate, in addition to the air at said at least one vehicle interior space.
